(19) United States
(12) Patent Application Publication
(10) Pub. No.: US 2026/0203796 A1
(43) Pub. Date: Jul. 16, 2026

(54) AUTOMATED EVALUATION OF PERCEPTION-BASED QUALITY OF VIRTUAL ASSETS

(71) Applicant: Roblox Corporation, San Mateo, CA (US)

(72) Inventors: Phani Harish WAJJALA, Foster City, CA (US); Mohan JIANG, San Mateo, CA (US); Brandon TRAN, San Mateo, CA (US)

(73) Assignee: Roblox Corporation, San Mateo, CA (US)

(21) Appl. No.: 19/449,064

(22) Filed: Jan. 14, 2026

Related U.S. Application Data
(60) Provisional application No. 63/745,141, filed on Jan. 14, 2025.

(51) Int. Cl. G06Q 30/0282; G06F 40/40; G06T 15/10; G06T 19/00; G06Q 30/0601

(52) U.S. Cl. CPC G06Q 30/0282; G06F 40/40; G06T 15/10; G06T 19/00; G06Q 30/0641

(57) ABSTRACT

Various implementations relate to methods, systems, and computer-readable media for scoring virtual assets in a virtual platform. According to one aspect, a computer-implemented method includes assigning respective asset types to virtual assets using semantic tags and sampling a subset of virtual assets from each of two or more asset types to generate multiple subsets. Each virtual asset in the subsets is evaluated based on a set of criteria. An artificial intelligence (AI) model generates prompts corresponding to the criteria by analyzing distinguishing attributes between virtual assets that meet or fail to meet a threshold under the criteria. Composite images are constructed for each virtual asset. The composite images, semantic tags, and prompts are input to the AI model to generate quality scores for each criterion and an overall quality score per asset. The overall scores are used within one or more applications of the platform.

### CROSS-REFERENCE TO RELATED APPLICATIONS

This application is a non-provisional patent application that claims priority under 35 U.S.C. § 119(e) to U.S. Provisional Patent Application No. 63/745,141, filed January 14, 2025, and titled “AUTOMATED EVALUATION OF PERCEPTION-BASED QUALITY OF VIRTUAL ASSETS,” the entire contents of which are incorporated by reference herein.

### TECHNICAL FIELD

Various implementations described herein relate generally to virtual assets within virtual platforms, and more particularly but not exclusively, to methods, systems, and computer-readable media for providing evaluation of quality of virtual assets within virtual platforms.

### BACKGROUND

Evaluation and curation of virtual assets, such as clothing, accessories, and other 3D items (e.g., that can be worn by an avatar or otherwise used in a virtual environment), is useful to enable and maintain engaging virtual platforms and online marketplaces. Traditionally, such platforms rely on user-generated content (UGC) and basic recommendation techniques that attempt to optimize for metrics such as purchase probability or popularity. The metrics fail or are otherwise inadequate/inefficient to capture the quality and appeal of virtual assets as perceived by participants in the virtual platform (e.g., human players). This can lead to a proliferation of low-quality, generic, or miscategorized items that degrade the user experience of participating in a virtual environment hosted by the virtual platform.

Current methods for evaluating the quality of virtual assets rely heavily on manual review or rudimentary filtering mechanisms. Manual reviews are labor-intensive, subjective, and difficult to scale as marketplaces for virtual assets grow to include millions of assets. While automated techniques can flag items based on simple heuristics, such as detecting inappropriate content or duplicate assets, they lack the nuance to determine attributes such as, for example, design sophistication, creativity, or how well an asset integrates with an avatar. Consequently, high-quality items are overlooked (e.g., not recommend to users, or remain unused or at low usage levels on the virtual platform), and low-quality items remain visible to users and in use.

Some platforms have attempted to address this issue by using basic visual analysis tools or user feedback to guide curation. For example, techniques that measure texture resolution (or another texture attribute), polygon counts, or other complexity attributes can identify technical flaws in virtual assets, but the tools fail to account for the perceived quality of an item from the perspective of users. Analogously, user ratings or reviews can provide insight into asset quality, but such data is inconsistent due to varying user preferences and expectations. In some cases (e.g., for new assets), user ratings/reviews are unavailable.

The lack of a robust quality evaluation framework creates several challenges. Low-quality or poorly integrated virtual assets can reduce user engagement and erode trust in the platform. Mischaracterized assets or items with simplistic designs may be included in or even dominate recommendation feeds due to price or popularity, thereby overshadowing unique and well-crafted items.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to provide evaluation of quality of virtual assets within a virtual platform.

According to one aspect, a computer-implemented method includes assigning respective asset types to a number of virtual assets within a virtual platform, wherein the assigning includes using semantic tags. A subset of virtual assets is sampled from each of two or more of the asset types, thereby generating a number of subsets. Each virtual asset in the subsets is evaluated based on a set of criteria. Using an artificial intelligence (AI) model, a set of prompts corresponding to the criteria is generated by analyzing distinguishing attributes between virtual assets in the subsets that meet a threshold under the criteria and virtual assets in the subsets that fail to meet the threshold under the criteria. Composite images are constructed for each virtual asset in the subsets, where each composite image includes a plurality of rendered views of an avatar equipped with the virtual asset. The composite images, the semantic tags, and the generated set of prompts are provided as input to the AI model. A set of quality scores associated with the criteria for each virtual asset in the subsets and an overall quality score for each virtual asset in the subsets are received as output from the AI model. The overall quality scores for the virtual assets in the subsets are utilized within one or more applications within the virtual platform.

In some implementations, evaluating each virtual asset includes excluding a virtual asset from the evaluation based on one or more eligibility conditions defined by a filtering policy.

In some implementations, the set of criteria includes one or more of visual appeal, design sophistication, perceived complexity, creativity, and fit and integration.

In some implementations, the set of criteria includes theme consistency, and the theme consistency is determined based on alignment between the virtual asset and a modeled distribution of semantically related assets.

In some implementations, differences are analyzed in attribute distributions between virtual assets in the subsets that meet the threshold under the criteria and virtual assets in the subsets that fail to meet the threshold. The set of prompts is generated based on the analyzing the differences in the attribute distributions.

In some implementations, each composite image includes multiple rendered views of the avatar, where each rendered view depicts a different orientation of the virtual asset as equipped on the avatar.

In some implementations, image data and metadata associated with each virtual asset in the number of virtual assets are analyzed to generate the semantic tags used for assigning the respective asset types.

In some implementations, the AI model is further configured to generate, for each virtual asset in the subsets, an explanation for at least one of the quality scores associated with the criteria.

In some implementations, the overall quality score is computed by applying a weighted aggregation to the quality scores associated with the criteria, where the weights are assigned based on importance values.

In some implementations, the set of prompts are updated based on differences between the quality scores output from the AI model and feedback received from human evaluators.

In some implementations, utilizing the overall quality scores includes adjusting a display ranking of the virtual assets in a content discovery interface of the virtual platform.

In some implementations, utilizing the overall quality scores includes adjusting one or more incentive parameters associated with a creator account linked to each respective virtual asset.

In some implementations, the AI model comprises a large language model (LLM).

According to another aspect, a computing device includes one or more processors, and memory coupled to the one or more processors with instructions stored thereon that, when executed by the one or more processors, cause the one or more processors to perform or control performance of operations including assigning respective asset types to a number of virtual assets within a virtual platform, wherein the assigning includes using semantic tags. A subset of virtual assets is sampled from each of two or more of the asset types, thereby generating a number of subsets. Each virtual asset in the subsets is evaluated based on a set of criteria. Using an AI model, a set of prompts corresponding to the criteria is generated by analyzing distinguishing attributes between virtual assets in the subsets that meet a threshold under the criteria and virtual assets in the subsets that fail to meet the threshold under the criteria. Composite images are constructed for each virtual asset in the subsets, where each composite image includes a plurality of rendered views of an avatar equipped with the virtual asset. The composite images, the semantic tags, and the generated set of prompts are provided as input to the AI model. A set of quality scores associated with the criteria for each virtual asset in the subsets and an overall quality score for each virtual asset in the subsets are received as output from the AI model. The overall quality scores for the virtual assets in the subsets are utilized within one or more applications within the virtual platform.

In some implementations, evaluating each virtual asset includes excluding a virtual asset from the evaluation based on one or more eligibility conditions defined by a filtering policy.

In some implementations, the set of criteria includes one or more of visual appeal, design sophistication, perceived complexity, creativity, and fit and integration.

In some implementations, the set of criteria includes theme consistency, where the theme consistency is determined based on alignment between the virtual asset and a modeled distribution of semantically related assets.

In some implementations, differences are analyzed in attribute distributions between virtual assets in the subsets that meet the threshold under the criteria and virtual assets in the subsets that fail to meet the threshold. The set of prompts is generated based on the analyzing the differences in the attribute distributions.

In some implementations, each composite image comprises multiple rendered views of the avatar, and each rendered view depicts a different orientation of the virtual asset as equipped on the avatar.

According to another aspect, a non-transitory computer-readable medium includes instructions stored thereon that, when executed by a processor, cause the processor to perform or control performance of operations including assigning respective asset types to a number of virtual assets within a virtual platform, wherein the assigning includes using semantic tags. A subset of virtual assets is sampled from each of two or more of the asset types, thereby generating a number of subsets. Each virtual asset in the subsets is evaluated based on a set of criteria. Using an AI model, a set of prompts corresponding to the criteria is generated by analyzing distinguishing attributes between virtual assets in the subsets that meet a threshold under the criteria and virtual assets in the subsets that fail to meet the threshold under the criteria. Composite images are constructed for each virtual asset in the subsets, where each composite image includes a plurality of rendered views of an avatar equipped with the virtual asset. The composite images, the semantic tags, and the generated set of prompts are provided as input to the AI model. A set of quality scores associated with the criteria for each virtual asset in the subsets and an overall quality score for each virtual asset in the subsets are received as output from the AI model. The overall quality scores for the virtual assets in the subsets are utilized within one or more applications within the virtual platform.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to provide evaluation of perception-based quality of virtual assets within a virtual platform, in accordance with some implementations.

FIG. 2 is a flow diagram illustrating an example method to provide evaluation of quality of virtual assets within virtual platforms, in accordance with some implementations.

FIG. 3 is a diagram illustrating an example pipeline for evaluating the quality of virtual assets, in accordance with some implementations.

FIG. 4A is a diagram illustrating example scoring results for a set of higher-quality virtual assets in the category of hair, in accordance with some implementations.

FIG. 4B is a diagram illustrating additional example virtual assets in the hair category with lower aggregate scores across multiple evaluation criteria, in accordance with some implementations.

FIG. 5 is a diagram illustrating an example comparative evaluation of virtual assets categorized under pants, including cases of miscategorization, in accordance with some implementations.

FIG. 6 is a diagram illustrating an example composite image associated with a virtual asset, in accordance with some implementations.

FIG. 7 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, “aspect”, “aspects”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to evaluating virtual assets within a virtual platform using AI models to produce quality scores that reflect subjective design criteria. The techniques include assigning semantic asset types to a plurality of virtual assets, sampling subsets from multiple asset types, and analyzing the sampled assets against design-related criteria such as, e.g., visual appeal, creativity, and perceived complexity. A set of AI-generated prompts is used to guide scoring by highlighting distinguishing attributes of higher-performing versus lower-performing assets, and composite images of avatars equipped with each virtual asset are created to enable richer evaluation.

The system uses the composite images, along with semantic tags and the AI-generated prompts, as input to an AI model, such as an LLM, to output per-criteria quality scores and overall quality scores for each asset. In some implementations, the composite images include multiple rendered views of each avatar. In some implementations, the quality scores provide a multi-dimensional determination of the design merit of each asset across a set of evaluation criteria. In some implementations, the scoring may also incorporate filtering to exclude ineligible assets based on defined policies or metadata.

In some implementations, the quality scores generated by the model may be used to adjust content ranking in user interfaces, influence rewards or incentives provided to asset creators, or support internal design curation workflows. By generating prompts from observed differences between high- and low-quality assets, the model is iteratively refined to improve performance on subjective dimensions, such as theme consistency or integration with avatar proportions. In some implementations, feedback loops involving human reviewers may also be used to update the prompts or scoring model. In some implementations, explanations for individual quality scores may be generated for transparency and interpretability.

Technical advantages of various features described herein include automating subjective quality evaluations of virtual assets using structured inputs and AI-based scoring. Manual review by human moderators limits scalability and introduces inconsistency. The described approach uses AI models to apply evaluation criteria in a repeatable, data-driven manner suitable for large asset repositories.

Another technical advantage of some implementations is using prompts generated from differences between assets that meet or fail to meet thresholds. This enables the AI model to reflect platform-specific design standards, capturing subtle distinctions in asset quality. As a result, the model can generate more accurate and context-aware scores without relying solely on general pretrained representations.

Another technical advantage of some implementations is using composite images showing multiple views of avatars equipped with virtual assets. The inputs help the model determine qualities like fit, coverage, and harmony that are not captured by single views or metadata. This supports holistic quality evaluation while remaining compatible with vision-language model architectures.

Another technical advantage of some implementations is modularity and explainability. The scoring pipeline can be adapted or audited through its use of semantic tags, prompts, and configurable inputs. Structured prompts aligned to scoring criteria provide interpretable feedback for asset creators, aiding transparency in creator-facing workflows.

Another technical advantage of some implementations is enabling near-real-time scoring without retraining the model per submission. By decoupling prompt generation and rendering from inference, the same prompts and model weights can be reused. Integration with storefronts or moderation systems can be enabled without added latency or retraining effort.

Another technical advantage of some implementations is enabling consistent scoring across multiple criteria using a unified input pipeline. This allows creativity, fit, or complexity scores to be compared and aggregated. Downstream applications can rank, filter, or reward assets based on uniform scoring.

### SYSTEM ARCHITECTURE

The present disclosure is directed towards, inter alia, techniques to provide evaluation of quality of virtual assets within virtual platforms.

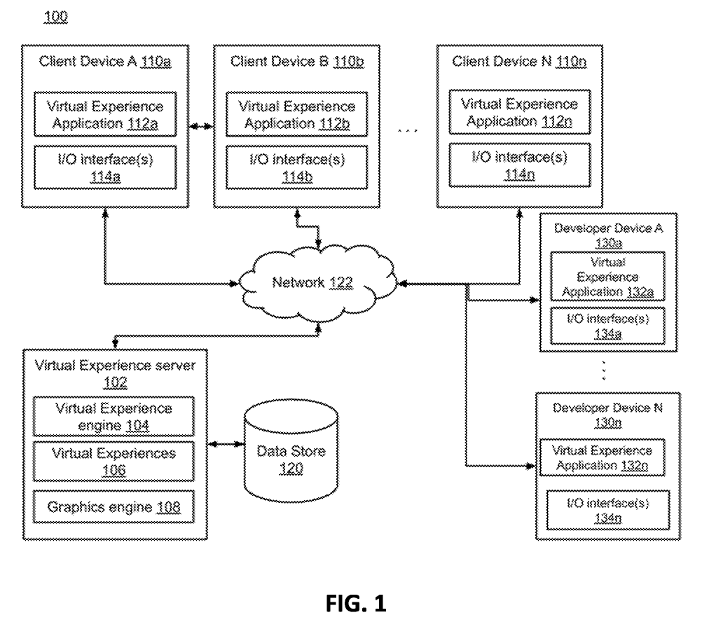

FIG. 1 is a diagram of an example system architecture to provide evaluation of perception-based quality of virtual assets within a virtual platform. FIG. 1 and the other figures use like reference numerals to identify similar elements. A letter after a reference numeral, such as “110," indicates that the text refers specifically to the element having that particular reference numeral. A reference numeral in the text without a following letter, such as "110," refers to any or all of the elements in the figures bearing that reference numeral (e.g. "110" in the text refers to reference numerals “110a," “110b," and/or “110n” in the figures).

The system architecture 100 (also referred to as “system” herein) includes online virtual experience server 102, data store 120, client devices 110a, 110b, and through 110n (generally referred to as “client device(s) 110” herein), and developer devices 130a and through 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

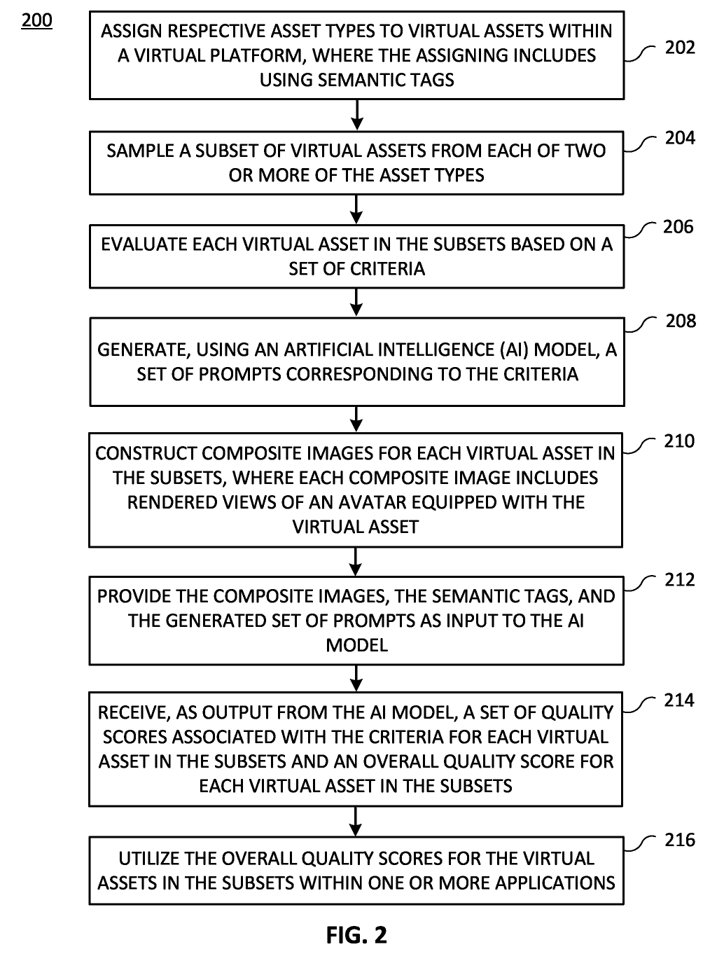

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 (and/or other component(s) of the online virtual experience server 102) may perform one or more of the operations described below in connection with the flowchart shown in FIG. 2 and/or other operations described herein. In one or more additional or alternative implementations, the operations described below may be performed on one or more client devices 110, or one or more developer devices 130. In some implementations, where the operations are performed depends at least in part on computational resources (e.g., memory, processing power, or disk space). A client device 110 can include a virtual experience application 112 and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132 and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, augmented reality (AR) experiences, or combinations thereof, for example. In some implementations, users may participate in interactions (such as gameplay) with other users. In some implementations, a virtual experience may be experienced in real-time or near-real-time with other users of the virtual experience. Various features/capabilities may be described at times herein with reference to a game—it is understood that such reference to a game is for purposes of illustration and example, and that the various features/capabilities described herein can be adapted for other types of implementations of virtual environments that do not necessarily involve games.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 and/or other component(s) of the online virtual experience server 102 implements the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, AI engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine and virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience application 112 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be interacting within a virtual experience 106 on client devices 110, and may send control instructions (e.g., user inputs, such as right, left, up, down, user election, or avatar position and velocity information, etc.) to the online virtual experience server 102. Subsequent to receiving control instructions from the client devices 110, the online virtual experience server 102 may send experience instructions (e.g., position and velocity information of the avatars participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (e.g., avatar) of the user within the virtual experience. For example, control instructions may include user input to control action within the experience, such as right, left, up, down, user selection, gyroscope position and orientation data, force sensor data, etc. The control instructions may include avatar position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, avatars (or virtual experience objects generally) are constructed from components, one or more of which may be selected by the user, that automatically join together to aid the user in editing.

In some implementations, an avatar is implemented as a 3D model and includes a surface representation used to draw the avatar (also known as a skin or mesh) and a hierarchical set of interconnected bones (also known as a skeleton or rig). The rig may be utilized to animate the avatar and to simulate motion and action by the avatar. The 3D model may be represented as a data structure, and one or more parameters of the data structure may be modified to change various properties of the avatar, e.g., dimensions (height, width, girth, etc.); body type; movement style; number/ type of body parts; proportion (e.g., shoulder and hip ratio); head size; etc.

One or more avatars (also referred to as a “character” or “model” herein) may be associated with a user where the user may control the avatar to facilitate an interaction of the user with the virtual experience 106.

In some implementations, an avatar may include components such as body parts (e.g., hair, arms, legs, etc.) and accessories (e.g., t-shirt, glasses, decorative images, tools, etc.). In some implementations, body parts of avatars that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users access to simplified 3D virtual object models that are represented by a mesh of a low polygon count (e.g., between about 20 and about 30 polygons).

In some implementations, the user may control the scale (e.g., height, width, or depth) of an avatar or the scale of components of an avatar. In some implementations, the user may control the proportions of an avatar (e.g., blocky, anatomical, etc.). It may be noted that in some implementations, an avatar may not include an avatar virtual experience object (e.g., body parts, etc.) but the user may control the avatar (without the avatar virtual experience object) to facilitate the interaction of the user with the virtual experience (e.g., a puzzle game where there is no rendered avatar game object, but the user still controls an avatar to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish an avatar of a user for view or use by other users of the online virtual experience server 102. In some implementations, creating, modifying, or customizing avatars, other virtual experience objects, virtual experiences 106, or virtual experience environments may be performed by a user using an I/O interface (e.g., developer interface) and with or without scripting (or with or without an application programming interface (API)). It may be noted that for purposes of illustration, avatars are described as having a humanoid form. It may further be noted that avatars may have any form such as a vehicle, animal, animate or inanimate object, or other creative form.

In some implementations, the online virtual experience server 102 may store avatars created by users in the data store 120. In some implementations, the online virtual experience server 102 maintains an avatar catalog and virtual experience catalog that may be presented to users. In some implementations, the virtual experience catalog includes images of virtual experiences stored on the online virtual experience server 102. In addition, a user may select an avatar (e.g., an avatar created by the user or other user) from the avatar catalog to participate in the chosen virtual experience. The avatar catalog includes images of avatars stored on the online virtual experience server 102. In some implementations, one or more of the avatars in the avatar catalog may have been created or customized by the user. In some implementations, the chosen avatar may have avatar settings defining one or more of the components of the avatar.

In some implementations, an avatar of a user can include a configuration of components, where the configuration and appearance of components and more generally the appearance of the avatar may be defined by avatar settings. In some implementations, the avatar settings of an avatar of a user may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application 112 may be a web application (e.g., an application that operates in conjunction with a web browser) that can access, retrieve, present, or navigate content (e.g., virtual avatar in a virtual experience, etc.) served by a web server. In another example, the virtual experience application 112 may be a native application (e.g., a mobile application, app, virtual experience program, or a gaming program) that is installed and executes local to client device 110 and enables users to interact with online virtual experience server 102. The virtual experience application 112 may render, display, or present the content (e.g., a web page, a media viewer) to a user. In an implementation, the virtual experience application 112 may include an embedded media player (e.g., a Flash® or HTML5 player) that is embedded in a web page.

According to aspects of the disclosure, the virtual experience application 112 may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application 112 may be provided to the client device(s) 110 by the online virtual experience server 102. In another example, the virtual experience application 112 may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual avatar in a virtual experience hosted by online virtual experience server 102, or view or upload content, such as virtual experiences 106, images, video items, web pages, documents, and so forth. In one example, the virtual experience application 132 may be a web application (e.g., an application that operates in conjunction with a web browser) that can access, retrieve, present, or navigate content (e.g., virtual avatar in a virtual experience, etc.) served by a web server. In another example, the virtual experience application 132 may be a native application (e.g., a mobile application, app, virtual experience program, or a gaming program) that is installed and executes local to developer device 130 and enables developer user(s) to interact with online virtual experience server 102. The virtual experience application 132 may render, display, or present the content (e.g., a web page, a media viewer) to a developer user. In an implementation, the virtual experience application 132 may include an embedded media player (e.g., a Flash® or HTML5 player) that is embedded in a web page.

According to aspects of the disclosure, the virtual experience application 132 may be an online virtual experience server application for developer users to build, create, edit, and upload content to the online virtual experience server 102 as well as interact with online virtual experience server 102 (e.g., provide and/or engage in virtual experiences 106 hosted by online virtual experience server 102). As such, the virtual experience application 132 may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application 112/132. The user may access a user account by providing user account information (e.g., username and password) where the user account is associated with one or more avatars available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server or other device(s) in the system architecture 100, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, a virtual platform server (which can be embodied by the online virtual experience server 102 and/or other device(s) in the system architecture 100) includes a quality evaluation component that executes logic for processing composite image data, semantic tags, and prompt information to generate quality determinations of virtual assets. The quality evaluation component may perform the techniques described herein, including analyzing semantic metadata and rendered visual content of avatars equipped with virtual assets, generating prompts corresponding to quality criteria, and invoking AI models to output quality scores and aggregated ratings. The component may also coordinate prompt construction based on distinguishing attributes of assets that meet or fail to meet quality thresholds. By performing scoring and aggregation operations server-side, consistent evaluations can be generated at scale without imposing computational load on client devices.

Client devices (e.g., 110) execute a platform application (e.g., 112) that transmits rendered composite images, semantic tags, or asset metadata to the server and receives quality scores and evaluation outputs in response. In some implementations, the platform application may transmit asset identifiers or creator-facing signals that support feedback delivery or downstream moderation. The platform application may locally cache evaluation results or metadata for reuse in preview interfaces or editing workflows. In some configurations, the client device may perform interface-layer functions such as ordering, filtering, or presenting evaluation results, while preserving the server-determined scores and criteria mapping.

### Evaluation of perception-based quality of virtual assets within a virtual platform

FIG. 2 is a flow diagram illustrating an example method 200 to provide evaluation of quality of virtual assets within virtual platforms, in accordance with some implementations.

In various implementations, the blocks shown in FIG. 2 and described below may be performed by any of the computing devices illustrated in FIG. 1, for example, by one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, respective asset types are assigned to a number of virtual assets within a virtual platform. The assigning includes using semantic tags. In some implementations, a virtual platform includes an online environment in which users interact through digital representations, participate in experiences, and customize those representations using digital goods. In some implementations, the virtual platform includes asset management services, user interface applications, and rendering engines. Within the platform, various digital goods can be stored, rendered, and transmitted. In some implementations, the digital goods include virtual assets, which include user-generated or system-generated 3D models, 2D images, textures, scripts, and composite packages intended for display, interaction, or configuration in the platform. Examples of virtual assets include wearable items such as hats, glasses, and clothing, as well as emotes (e.g., predefined avatar animations such as waving, dancing, or reacting), animation packages, virtual accessories, textures, avatars, and layered assemblies of components.

Each virtual asset is assigned a respective asset type. In some implementations, an asset type includes a category identifier used to group virtual assets based on their intended function, structure, or usage context. For example, asset types may include headwear, footwear, upper-body apparel, full-body outfits, animation sequences, or ambient environment attachments. Assignment of an asset type is used to facilitate classification, presentation, filtering, and further evaluation of the asset. The asset type assigned to a virtual asset influences how the asset is previewed on avatars, where it is displayed in the catalog, and how compatibility with other assets is determined.

In some implementations, the assignment of an asset type to a virtual asset includes analysis of the data for the asset to identify relevant characteristics. The assignment utilizes semantic tags, which include metadata descriptors associated with the asset. In some implementations, semantic tags may include information such as intended body location, theme, color scheme, material type, compatibility flags, or descriptive keywords provided by the creator or inferred through automated processing. For example, a virtual asset that includes a 3D model with upper-torso fitting geometry and “hoodie” in its filename or creator-supplied metadata may be assigned the asset type “upper-body apparel” based on a semantic tag match.

In some implementations, semantic tags are extracted or generated using one or more automated models. In some implementations, a tag classification model receives as input the associated metadata and geometric information of the virtual asset, and outputs a set of semantic tags. The input metadata includes the asset name, creator-provided descriptions, previously associated tags, and usage history. Geometric information includes mesh dimensions, vertex positioning, bounding box data, and relative orientation. The classification model uses the inputs to assign tags such as “hat,” “shirt,” “accessory,” “Halloween,” “formal,” or “animated.”

In some implementations, the semantic tags produced by the classification model are utilized as part of a tagging pipeline that feeds into the asset type assignment logic. For example, if an asset has the tags “face accessory” and “mask,” the assignment logic may assign the asset type “facial wearable.” In some implementations, in cases where the tags are ambiguous or conflict with each other, a fallback resolution strategy is applied, which may include defaulting to a general-purpose asset type or requesting manual intervention from a platform moderator.

In some implementations, asset type assignment is performed as part of a batch or streaming workflow. In a batch context, newly uploaded assets are processed in groups, and semantic tags are generated or confirmed in parallel. In a streaming or near-real-time configuration, assets are processed upon upload or edit, and assignment occurs inline with validation. In some implementations, the output of the asset type assignment includes a mapping between asset identifiers and asset types, which is stored in an asset database of the virtual platform.

In some implementations, the semantic tags used to assign respective asset types are generated by analyzing image data and metadata associated with each virtual asset in the number of virtual assets. The image data may include one or more rendered images, texture maps, or geometry-derived visual representations of the virtual asset, while the metadata may include creator-provided labels, asset titles, category hints, usage history, or structural descriptors. In some implementations, an AI model processes the image data to extract visual features such as shape, silhouette, surface detail, or attachment points, and processes the metadata to extract textual or categorical signals. The extracted features and signals are combined to produce one or more semantic tags that characterize the function or category of the virtual asset, such as clothing, accessory, body part modification, or animation-related content. Block 202 is followed by block 204.

At block 204, a subset of virtual assets is sampled from each of two or more of the asset types, thereby generating multiple subsets. Sampling includes selecting a representative portion of virtual assets from each of the asset types to enable subsequent evaluation and analysis. In some implementations, the sampling operation may be performed programmatically by a selection module operating within a backend pipeline, using deterministic or stochastic logic to choose assets based on selection criteria or statistical distribution.

In various implementations, sampling may include a range of possible selection techniques. In some implementations, a uniform random sampling technique is applied within each asset type so that assets are evenly selected regardless of their creation time, popularity, or creator identity. In some implementations, stratified sampling is used so that specific characteristics (e.g., metadata richness, creation date, or usage frequency) are represented proportionally or otherwise correspondingly within the sample. In some implementations, weighted sampling may also be utilized, where the probability of inclusion of an asset in the sample is proportional or otherwise corresponds to a weight value assigned based on one or more criteria.

For example, from an asset type corresponding to headwear, the system may sample 50 out of 10,000 total virtual assets. The 50 may include highly popular hats, recently uploaded user-generated helmets, and rarely used novelty headpieces. From an asset type corresponding to avatar animations, the system may sample a selection of walking, running, and dancing animations across different creators and release dates. The resulting subsets reflect a cross-section of the broader asset type category, enabling generalization of downstream model predictions.

In some implementations, sampling is performed in multiple stages. A first-stage sampling may select a coarse subset across all asset types to estimate overall distributional properties, while a second-stage sampling may apply refinement rules to narrow the selection based on visual characteristics, complexity scores, or metadata patterns.

In some implementations, the size of the sampled subset per asset type may be configurable. For example, the system may be configured to sample a fixed number (e.g., 100 assets per type) or a percentage of total assets (e.g., 1%) for each type. In some implementations, dynamic sampling logic is used to adjust sample sizes based on available compute resources, observed data variability, or coverage targets. In some implementations, sampling operations may include logging and audit features to record which assets were selected, the method of selection, and the context of the sampling execution. Block 204 is followed by block 206.

At block 206, each virtual asset in the subsets is evaluated based on a set of criteria. In some implementations, the set of criteria may be predefined based on platform-specific guidelines, model training objectives, or content quality metrics, and may include dimensions such as visual distinctiveness, geometric complexity, contextual fit, and stylistic coherence. In some implementations, the evaluation is performed by one or more processing components of the virtual platform. In some implementations, the evaluation includes computing one or more score values for each asset that reflect its characteristics as interpreted according to the evaluation logic. The score values may be stored in association with asset identifiers and used in later stages of asset ranking or recommendation.

In some implementations, the set of criteria defines the dimensions along which the assets are analyzed. In some implementations, the set of criteria may include measurable or inferable properties such as visual appeal, design complexity, aesthetic cohesion, spatial integration with other assets, or expressiveness. In various implementations, the platform may use numeric scores, categorical labels, or multi-dimensional embeddings to represent the outcome of each criterion per asset.

In various implementations, evaluation may use model-based and/or rule-based approaches. For example, one or more machine-learned models may be invoked to estimate visual appeal or perceived creativity by processing rendered images or metadata of the virtual asset. The models may be convolutional neural networks, transformer-based architectures, or other types of trained models operating on visual or textual input. Rule-based logic may be used to evaluate fit characteristics, such as determining whether a hair accessory intersects with a bounding region of an avatar when rendered in standard poses.

In some implementations, input data to the evaluation process includes asset files, associated metadata, semantic tags, and rendered previews of the asset in isolation or in context (e.g., on an avatar). The evaluation component may generate standardized renderings using a shared rendering engine to reduce variability due to viewing angle, lighting, or avatar differences. In some implementations, composite images showing multiple assets in use are also used as input to evaluation models.

In various implementations, the evaluation may be performed synchronously with the sampling or asynchronously as a background batch process. In some implementations, evaluation metadata, including score breakdowns and model confidence values, may be persisted in a database indexed by asset identifiers. In some implementations, evaluation results include flags indicating evaluation anomalies, such as missing geometry or misaligned textures.

In some implementations, the resulting evaluation data is formatted as structured records including the asset identifier, asset type, and a set of scores or labels corresponding to the criteria. The data is used by downstream components in the pipeline to rank virtual assets, determine composite image arrangements, or generate training examples for additional models. Evaluation may also support audit and interpretability features, such as exposing the scoring rationale for selected assets or validating the consistency of evaluation outputs across model versions.

In some implementations, the evaluating of each virtual asset includes determining whether the virtual asset satisfies one or more eligibility conditions specified by a filtering policy. The filtering policy includes defined rules or thresholds that are applied prior to or during the evaluation to exclude virtual assets deemed ineligible for scoring. The eligibility conditions may relate to metadata attributes, usage restrictions, moderation status, or compliance with predefined content guidelines of the virtual platform.

For example, a filtering policy may specify that virtual assets with incomplete metadata, missing semantic tags, or lacking required asset previews are excluded from the evaluation. In some implementations, assets that have been previously flagged for policy violations or are pending moderation review may be automatically filtered out. By applying the filtering policy, the evaluation pipeline processes the virtual assets that are both eligible and sufficiently described for meaningful quality determination, in order to preserve the integrity of scoring operations and prevent skew introduced by incomplete or disqualified inputs.

In some implementations, the set of criteria used to evaluate each virtual asset includes one or more attributes that reflect different aspects of the asset quality and its impact on user experience. The set of criteria may include one or more of, e.g., visual appeal, design sophistication, perceived complexity, creativity, and/or fit and integration. Each of the one or more attributes captures a specific evaluative dimension that contributes to the scoring and ranking for the asset. Visual appeal includes how aesthetically pleasing the virtual asset appears in rendered form, such as color harmony, texture resolution, lighting behavior, and visual clarity. Design sophistication includes the level of detail or refinement expressed in the asset geometry or style, such as detailed modeling or nuanced shading. Perceived complexity includes the extent to which the asset appears intricate, either in structure or in composition. Creativity includes the originality or distinctiveness of the asset relative to similar virtual items. Fit and integration includes how well the asset aligns with other visual components or avatar configurations in the virtual platform, such as joint alignment, coordinated appearance, or thematic consistency. In various implementations, the criteria may be embedded in prompt data or incorporated into scoring heuristics used by the AI model.

In some implementations, one of the criteria used to evaluate virtual assets includes theme consistency. The theme consistency is determined based on alignment between the virtual asset and a modeled distribution of semantically related assets. In some implementations, theme consistency includes how well a virtual asset aligns with a target theme that may be implicit or explicit in the virtual platform context. The theme may correspond to a predefined aesthetic category, seasonal motif, brand identity, or contextual scenario, such as futuristic, medieval, aquatic, or holiday-themed environments.

In some implementations, the determination of theme consistency may be performed by comparing the semantic properties of a virtual asset against a modeled distribution of semantically related assets. The modeled distribution includes a statistical or embedding-based representation of assets previously classified under the same theme, based on prior tagging, user interaction patterns, or clustering results. In some implementations, the semantic alignment is determined using similarity metrics applied to tag vectors, latent embeddings, or prompt-aligned descriptors. The AI model may incorporate the theme-based distribution as part of its evaluation inputs or scoring logic.

For example, a virtual platform may define a space explorer theme that includes futuristic helmets, space suits, oxygen backpacks, and zero-gravity accessories. A virtual asset such as a metallic shoulder guard may be evaluated for theme consistency by comparing its shape, texture, and color tags (e.g., “chrome,” “armor,” “utility”) against the modeled distribution of other assets in the space explorer category. If the tags align closely with the dominant features of that distribution, the asset may be assigned a high theme consistency score. If the asset includes attributes outside the distribution (e.g., organic textures, medieval flourishes), the theme consistency score may be reduced. Block 206 is followed by block 208.

At block 208, a set of prompts corresponding to the criteria is generated, using an AI model, by analyzing distinguishing attributes between virtual assets that meet a threshold under the criteria and virtual assets that fail to meet a threshold under the criteria. In some implementations, the prompts are generated by analyzing distinguishing attributes between virtual assets that meet a threshold under the criteria and virtual assets that fail to meet the threshold under the criteria. In this context, a prompt includes a structured or semi-structured input string, feature descriptor, or textual pattern that captures relevant attributes associated with quality differentiation, which can be used as input for further machine learning inference or guidance.

In some implementations, the generation of prompts may be performed by a machine-learning model trained to identify salient features that correlate with asset evaluation outcomes. The model may operate on feature representations of composite images, metadata, semantic tags, or other asset descriptors to determine patterns or attribute clusters. The patterns may include stylistic elements (e.g., color scheme, contour density), shape or geometry indicators (e.g., silhouette features), or usage metadata (e.g., frequency of equipping by users), which statistically separate higher-rated assets from lower-rated ones.

In some implementations, the model is trained using labeled examples of virtual assets previously scored or categorized according to the predefined evaluation criteria. During training, the model may compute embeddings or intermediate representations that reflect distinguishing features across the scored dataset. In some implementations, the representations are utilized to generate prompt components by selecting high-variance feature dimensions, attention-weighted token groupings, or classifier-derived concept indicators that correlate with scoring outcomes.

In some implementations, analyzing distinguishing attributes may include clustering virtual assets into groups that exceed or fail to meet specific scoring thresholds, and identifying features that contribute most to inter-group separation. For example, assets with high design sophistication scores may exhibit particular mesh complexity, symmetry, or thematic consistency, which are extracted via computer vision models or neural attention layers. The features are then abstracted into prompts that encode such differentiating characteristics in a form usable by downstream models.

In various implementations, generated prompts may take various forms depending on downstream usage. In some implementations, prompts may be textual, such as template-based phrases including attribute indicators (e.g., "high-detail sci-fi helmet with asymmetrical plating"). In some implementations, prompts may be structured representations suitable for conditioning models, including token sequences, embeddings, or visual descriptors that emphasize traits associated with high- or low-scoring assets. In various implementations, the AI model generating the prompts may include a vision-language transformer, contrastive encoder, or other hybrid architecture.

In some implementations, the model used to generate prompts is a large language model (LLM) configured to accept structured representations or annotated examples as input. The LLM may be conditioned using examples of virtual assets and their associated evaluation scores, and prompted to output generalized attribute descriptions that distinguish assets with higher scores under specific criteria. The LLM may generate textual prompt patterns for downstream classification or scoring models, based on its internal semantic representations of quality-related attributes across asset types. This allows for generalization across asset categories and enables the use of LLM-generated prompts in subsequent inferential pipelines.

In some implementations, the use of LLMs may enable prompt generation from multimodal data by combining metadata, semantic tags, and visual feature summaries into a unified input. For example, the system may supply the LLM with a set of attributes for high-scoring assets and a separate set for low-scoring assets under a given criterion, and the LLM may synthesize prompts that encapsulate the conceptual differences between the sets. The ability of the LLM to model compositional semantics and infer latent themes enables the LLM to generate prompts that are both descriptive and contextually aligned with platform-specific aesthetics or user preferences.

In some implementations, generation of the set of prompts includes analyzing differences in attribute distributions between virtual assets in the subsets that meet the threshold under the criteria and virtual assets in the subsets that fail to meet the threshold. Attribute distributions include statistical representations of various features associated with the virtual assets. The features may include semantic tags, visual attributes such as color or shape, usage metadata, or AI-generated embeddings. The AI model may receive as input the distributions for each attribute across both subsets of assets (e.g., those that satisfied the criteria thresholds and those that did not) and perform differential analysis to identify statistically significant divergences.

The analysis may include computing normalized frequency distributions, vector-based similarity scores, or dimensionality-reduced embeddings across the two asset groups. The resulting comparisons identify which attributes are most indicative of higher or lower scores under the criteria. For example, if assets meeting a creativity threshold exhibit a higher distribution of uncommon material combinations or abstract shape descriptors, the attributes are marked as distinguishing.

Based on the analysis of the differences in the attribute distributions, the system generates the set of prompts to guide further processing by the AI model. The prompts include natural language descriptions or structured template inputs that reflect the distinguishing attributes identified in the distribution analysis. By focusing on statistically differentiating features, the prompts encode higher-level insights about what traits correlate with quality criteria, supporting generation of quality scores aligned with those traits in downstream steps. The prompts are then incorporated as part of the input to the AI model. Block 208 is followed by block 210.

At block 210, composite images are constructed for each virtual asset in the subsets, where each composite image includes a number of rendered views of an avatar equipped with the virtual asset. A composite image includes a set of rendered views of an avatar equipped with the corresponding virtual asset. In this context, a composite image includes a digital image that is programmatically assembled to include multiple rendered perspectives or viewpoints of a three- dimensional representation of a subject, where the subject includes an avatar wearing or otherwise displaying a virtual asset. In various implementations, the composite image may be formatted as a single image strip, grid, or layered format suitable for downstream visual analysis or prompt generation.

An avatar includes a digital humanoid or non-humanoid model used to represent a user or character in a virtual platform. The virtual platform includes any interactive digital environment supporting user representation through avatars and digital assets. Examples include online games, metaverse environments, or virtual social platforms. In some implementations, virtual assets may be visually affixed to an avatar model, such as by attaching a hat to the head slot, rendering pants onto the leg portion of the mesh, or equipping accessories like capes, wings, or emotes (e.g., waving animations or stylized gestures).

In some implementations, each rendered view is generated from a specified camera angle or viewpoint, such as a front view, three-quarter view, side view, or top-down view. In some implementations, a rendered view includes a rasterized or otherwise visually synthesized image of the avatar and virtual asset from a defined spatial orientation, produced using a rendering engine. The rendering engine may apply lighting, shading, texture mapping, and background selection based on platform-defined configurations. The views capture visual characteristics of the asset from different perspectives to support evaluation, training, or inference tasks. In some implementations, each rendered view depicts a different orientation of the virtual asset as equipped on the avatar.

In some implementations, the rendered views are selected to convey different aspects of the geometry and surface properties of the virtual asset. For example, a front-facing view may reveal symmetrical features or facial alignment, while a back view may expose cape length or backpack structure. A side view may emphasize profile contours or protruding elements such as horns or accessories. In some implementations, the rendering includes use of environment-independent lighting conditions, uniform backgrounds, and fixed avatar poses to reduce variability between composite images and isolate asset-specific features.

In some implementations, the rendering pipeline applies standardization across asset types to allow for direct comparison. The avatar model may be held constant across all composite images, with only the target virtual asset changing. In some implementations, virtual assets may be resized or repositioned within the rendered view to conform to viewport dimensions or normalization requirements. Block 210 is followed by block 212.

At block 212, the composite images, the semantic tags, and the generated set of prompts are provided as input to the AI model. The composite images include rendered visual representations of avatars equipped with specific virtual assets, capturing the visual characteristics of those assets from multiple viewpoints. The semantic tags describe categorical or descriptive information about each asset, such as inferred type, function, or stylistic properties, and are generated using metadata and asset classification models.

In some implementations, the set of prompts includes structured natural language inputs generated by comparing assets that met evaluation thresholds against those that did not. The prompts encode descriptive patterns and attribute-level distinctions aligned with the evaluation criteria. When provided as part of the AI model input alongside composite images and semantic tags, the prompts serve to constrain or condition the inference of the AI model, emphasizing features associated with asset quality. The combined input structure enables the AI model to apply learned relationships across multiple modalities, including visual, textual, and categorical data, to perform downstream tasks such as scoring or labeling. Block 212 is followed by block 214.

At block 214, a set of quality scores associated with the criteria for each virtual asset in the subsets is received as output from the AI model. In some implementations, the quality scores include numerical or categorical indicators reflecting the AI model evaluation of how well a given virtual asset aligns with the established criteria. In some implementations, each criterion corresponds to a particular aesthetic, functional, or stylistic attribute, and the quality score for that criterion denotes the AI model determination of the presence or intensity of that attribute in the asset. For example, one criterion might relate to the visual cohesion of the asset with other avatar elements, while another might address visual clarity at different rendering resolutions.

In some implementations, the AI model generates a distinct quality score for each relevant criterion per virtual asset. If three criteria are specified, such as, e.g., consistency with avatar proportions, clarity under motion blur, and style matching with platform norms, the AI model may produce three corresponding quality scores for each virtual asset. In some implementations, the scores are derived from the AI model internal evaluation of the asset composite images, semantic tags, and associated prompts, which were provided as input in the prior processing.

In some implementations, in addition to per-criterion quality scores, the AI model outputs an overall quality score for each virtual asset. The overall quality score serves as a summary metric that synthesizes the individual criterion scores into a single evaluative value. In some implementations, the overall quality score may be computed by the AI model via a weighted aggregation of the per-criterion scores, where the weighting function is learned during model training or specified via external configuration. The resulting overall score can be used to facilitate sorting, filtering, or ranking virtual assets in downstream interfaces or moderation workflows.

In some implementations, the AI model is configured to generate, for each virtual asset in the subsets of virtual assets, an explanation associated with at least one of the quality scores assigned to that asset. In some implementations, the explanations may include natural language output that identifies one or more attributes that contributed to a higher or lower score under a particular criterion. For example, an explanation corresponding to the visual appeal criterion may include a textual description indicating that the asset includes a consistent color palette, balanced proportions, or distinctive decorative elements. The explanation may also identify deficiencies, such as low resolution textures or lack of detail, for assets with lower scores.

In some implementations, the generation of explanations may include conditioning on the same input used to produce the quality scores, including composite images, semantic tags, and the set of prompts. In some implementations, the AI model may incorporate attention mechanisms or token relevance tracking to associate specific features or prompt activations with corresponding score outcomes. In some implementations, the explanation output is provided alongside the quality scores for review, debugging, or interpretability purposes, and may be cached or embedded within metadata records for the corresponding asset.

In some implementations, the overall quality score for a virtual asset is computed by applying a weighted aggregation to the quality scores associated with the criteria, with the weights being assigned based on importance values. Each criterion is assigned a corresponding importance value that defines its relative contribution to the overall quality score. The importance values may be predefined by platform configuration, derived from historical evaluation data, or adjusted based on asset type or context within the virtual platform. The weighted aggregation may include computing a linear combination of the individual quality scores using the assigned importance values, followed by normalization to a defined scoring range. The aggregation produces a single overall quality score that reflects the relative influence of multiple criteria while preserving distinctions between different evaluation dimensions.

In some implementations, the set of prompts used by the AI model to generate quality scores is updated based on differences between the quality scores output from the AI model and evaluations provided by human reviewers. After receiving the quality scores, a feedback loop may be established in which human evaluators review the same virtual assets and provide independent determinations using scoring interfaces or annotation tools. The human-generated evaluation scores may include numerical ratings, categorical determinations, or multi-attribute rubrics aligned with the criteria.

In some implementations, the differences between the quality scores and the human evaluator feedback are analyzed to detect systematic variances in how particular attributes are weighted or interpreted. Based on the differences, the system may revise the prompt set to adjust the phrasing or focus of one or more prompts to better align with the evaluative expectations captured in the human feedback. For example, if assets rated highly by human evaluators for perceived complexity consistently receive lower scores from the AI model, the associated prompt may be rewritten to foreground indicators of intricacy or nested design elements. Block 214 is followed by block 216.

At block 216, the overall quality scores for the virtual assets in the subsets are utilized within one or more applications within the virtual platform. The overall quality scores may be stored in association with asset identifiers in platform databases and made accessible via internal APIs or services. In some implementations, applications within the virtual platform may query and retrieve the quality scores for use in automated decision-making pipelines or user-facing interfaces.

In some implementations, asset discovery interfaces within the virtual platform may utilize the overall quality scores to rank or filter virtual assets shown to end users. For example, a storefront or catalog interface may sort assets based on quality scores to prioritize higher-rated content. Alternatively, asset recommendation engines may combine the quality scores with user-specific engagement data to refine personalized suggestions.

In some implementations, the overall quality scores may be utilized in moderation or curation systems. In this context, assets falling below a quality threshold may be flagged for review or excluded from particular platform features. For example, an asset scoring below a configured threshold might be temporarily hidden from search results until reviewed by a moderator. Assets with high overall scores may be prioritized for promotion or inclusion in curated collections.

In some implementations, quality scores may be surfaced to asset creators as feedback within creator analytics dashboards. In some implementations, this may include visualizations of score distributions across multiple assets, per-criterion breakdowns, or historical trends. The dashboards can allow creators to understand how their assets are evaluated by the AI model and how their content compares to platform-wide quality benchmarks. In some implementations, creators may be enabled to view the prompts or criteria that influenced the score, without disclosing proprietary model internals.

In some implementations, the overall quality scores may be utilized to allocate resources or trigger workflows within the virtual platform. For example, assets with high scores may be fast-tracked for feature placement or integration into platform events. Scores may also inform decisions about asset compatibility with specific experiences or avatar configurations.

In some implementations, the overall quality scores generated by the AI model may be utilized to influence the visual presentation and ordering of virtual assets within a content discovery interface of the virtual platform. For example, one application may be a user-facing content discovery interface, which presents ranked lists, carousels, or search results of virtual assets such as avatar items, emotes, or accessories. In some implementations, the display ranking may be dynamically adjusted using the overall quality scores as an input signal to promote assets that score higher under the defined criteria. For example, when a user searches for “gold wings,” assets in that category that received higher overall quality scores may be positioned more prominently, while lower-scoring assets may appear further down in the list or be omitted entirely.

In some implementations, the virtual platform may apply the overall quality scores of virtual assets to dynamically influence incentive parameters tied to creator accounts linked to each respective virtual asset. Incentive parameters may include the eligibility of a creator for promotional placement, participation in monetization programs, increased revenue share percentages, or access to exclusive asset publishing tools. The incentive parameters may be configured to reward creators whose assets score higher according to criteria such as visual appeal, creativity, and thematic consistency.

For example, a virtual jacket designed by a creator that receives a high overall quality score may trigger an increase in the share of sales revenue for that creator or make the asset eligible for inclusion in curated platform storefronts. Assets that score below a threshold may result in reduced incentives or lower visibility. The use of quality scores in this manner introduces an automated and criteria-driven mechanism for aligning creator rewards with content quality.

In some implementations, one or more of blocks 202-216 may be performed by one or more server devices, and one or more of blocks 202-216 may be performed by one or more client devices. In some implementations, all of method 200 may be performed by a server device, or by a client device. In some implementations, one or more of blocks 202-216 may be performed in parallel. Various blocks may be omitted, combined, modified, supplemented with additional blocks, performed in a different order than depicted in FIG. 2, etc.

Some implementations may include the use of user data, such as interaction signals, avatar configurations, asset usage history, or platform engagement patterns. When such data is used, it is collected in accordance with applicable privacy laws and subject to user consent. Collection is limited to information necessary for supporting the evaluation of virtual assets, generation of semantic tags, refinement of prompts, computation of quality scores, and training or calibration of the AI model. Identifying information may be removed or anonymized prior to storage or analysis, with retained data restricted to non-identifiable elements required for system functionality. Data may be stored only for durations aligned with its evaluative or training purpose. Users may be offered mechanisms to control data collection, review stored data, or request deletion of associated records.

In various implementations, the techniques described herein may include combinations of one or more features recited in the claims. For example, in some implementations, a computer-implemented method includes assigning respective asset types to a plurality of virtual assets within a virtual platform, wherein the assigning includes using semantic tags; sampling a subset of virtual assets from each of two or more of the asset types, thereby generating a plurality of subsets; evaluating each virtual asset in the subsets based on a set of criteria; generating, using an AI model, a set of prompts corresponding to the criteria by analyzing distinguishing attributes between virtual assets in the subsets that meet a threshold under the criteria and virtual assets in the subsets that fail to meet the threshold under the criteria; constructing composite images for each virtual asset in the subsets, wherein each composite image comprises a plurality of rendered views of an avatar equipped with the virtual asset; providing the composite images, the semantic tags, and the generated set of prompts as input to the AI model; receiving, as output from the AI model, a set of quality scores associated with the criteria for each virtual asset in the subsets and an overall quality score for each virtual asset in the subsets; and utilizing the overall quality scores for the virtual assets in the subsets within one or more applications within the virtual platform. In some implementations, evaluating each virtual asset comprises excluding a virtual asset from the evaluation based on one or more eligibility conditions defined by a filtering policy and the set of criteria comprises one or more of visual appeal, design sophistication, perceived complexity, creativity, and fit and integration.

In some implementations, the computer-implemented method includes assigning respective asset types to a plurality of virtual assets within a virtual platform using semantic tags; sampling a subset of virtual assets from each of two or more of the asset types to generate a plurality of subsets; evaluating each virtual asset in the subsets based on a set of criteria; generating, using an AI model, a set of prompts corresponding to the criteria by analyzing distinguishing attributes between virtual assets in the subsets that meet a threshold under the criteria and virtual assets in the subsets that fail to meet the threshold under the criteria; constructing composite images for each virtual asset in the subsets, wherein each composite image comprises a plurality of rendered views of an avatar equipped with the virtual asset; providing the composite images, the semantic tags, and the generated set of prompts as input to the AI model; receiving quality scores and an overall quality score for each virtual asset in the subsets; and utilizing the overall quality scores within the virtual platform, wherein the set of criteria comprises theme consistency, and wherein the theme consistency is determined based on alignment between the virtual asset and a modeled distribution of semantically related assets, and wherein the set of prompts is generated based on analyzing differences in attribute distributions between virtual assets in the subsets that meet the threshold and virtual assets in the subsets that fail to meet the threshold.

In some implementations, the computer-implemented method includes assigning respective asset types to a plurality of virtual assets within a virtual platform using semantic tags; sampling a subset of virtual assets from each of two or more of the asset types to generate a plurality of subsets; evaluating each virtual asset in the subsets based on a set of criteria; generating prompts using an AI model by analyzing distinguishing attributes between virtual assets in the subsets that meet and fail to meet a threshold under the criteria; constructing composite images for each virtual asset in the subsets, wherein each composite image comprises multiple rendered views of the avatar and each rendered view depicts a different orientation of the virtual asset as equipped on the avatar; providing the composite images, the semantic tags, and the prompts as input to the AI model; receiving quality scores and an overall quality score for each virtual asset in the subsets; and utilizing the overall quality scores within one or more applications within the virtual platform, further including analyzing image data and metadata associated with each virtual asset in the plurality of virtual assets to generate the semantic tags used for assigning the respective asset types.

In some implementations, the computer-implemented method includes assigning respective asset types to a plurality of virtual assets using semantic tags; sampling a subset of virtual assets from each of two or more of the asset types; evaluating each virtual asset in the subsets based on a set of criteria; generating prompts using an AI model by analyzing distinguishing attributes between virtual assets in the subsets that meet and fail to meet a threshold under the criteria; constructing composite images comprising rendered views of an avatar equipped with the virtual asset; providing the composite images, semantic tags, and prompts as input to the AI model; receiving quality scores and an overall quality score for each virtual asset in the subsets; and utilizing the overall quality scores within the virtual platform, wherein the AI model is further configured to generate, for each virtual asset in the subsets, an explanation for at least one of the quality scores associated with the criteria.

In some implementations, the computer-implemented method includes assigning respective asset types to a plurality of virtual assets using semantic tags; sampling subsets of virtual assets from multiple asset types; evaluating each virtual asset in the subsets based on a set of criteria; generating prompts using an AI model by analyzing distinguishing attributes between virtual assets in the subsets that meet and fail to meet a threshold; constructing composite images with rendered avatar views; providing the composite images, semantic tags, and prompts to the AI model; receiving quality scores and an overall quality score for each virtual asset; and utilizing the overall quality scores within the virtual platform, wherein the overall quality score is computed by applying a weighted aggregation to the quality scores associated with the criteria, and wherein the weights are assigned based on importance values.

In some implementations, the computer-implemented method includes assigning asset types using semantic tags; sampling subsets from two or more asset types; evaluating each virtual asset based on criteria; generating prompts using an AI model by analyzing distinguishing attributes between threshold-meeting and threshold-failing assets; constructing composite images; providing composite images, semantic tags, and prompts to the AI model; receiving quality scores and overall quality scores; and utilizing the overall quality scores, further including updating the set of prompts based on differences between the quality scores output from the AI model and feedback received from human evaluators.

In some implementations, the computer-implemented method includes assigning asset types using semantic tags; sampling subsets from multiple asset types; evaluating assets based on criteria; generating prompts using an AI model; constructing composite images; providing inputs to the AI model; receiving quality scores and overall quality scores; and utilizing the overall quality scores by adjusting a display ranking of the virtual assets in a content discovery interface of the virtual platform or by adjusting one or more incentive parameters associated with a creator account linked to each respective virtual asset.

In some implementations of any of the above combinations, the AI model includes an LLM.

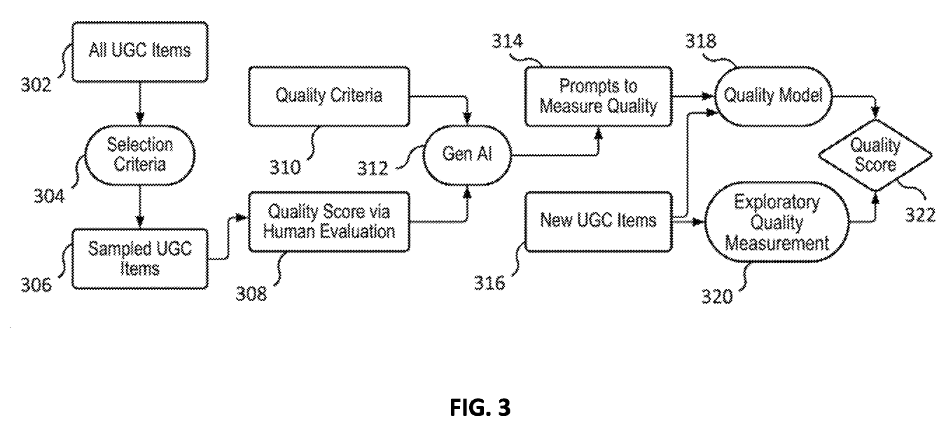

FIG. 3 is a diagram illustrating an example pipeline for evaluating the quality of virtual assets, referred to in this context as user-generated content (UGC) items, in accordance with some implementations. The process begins with a set of all UGC items 302. From the complete collection of UGC items, a subset is selected using selection criteria 304, resulting in a reduced set of sampled UGC items 306. The sampled virtual assets are used for training and evaluation procedures.

A portion of the sampled assets undergoes quality determination through human evaluation 308. Human reviewers evaluate the assets according to a set of quality criteria 310. The criteria specify measurable dimensions of quality, such as visual appeal, usability, originality, or other relevant attributes for the platform. The results of the evaluations, along with the criteria themselves, are input to a generative AI model 312.

The generative AI model uses the input to generate prompts 314 that serve as measurement tools for determining quality in new virtual assets. The prompts are used by the AI model to determine incoming virtual assets 316. The outputs of the determination feed into a quality model 318, which produces quality scores.

In addition to the main quality model, an exploratory quality measurement module 320 may be used to capture quality signals that fall outside criteria or to enable adaptive refinement of the scoring. The overall quality score 322 for each virtual asset can be derived from one or both scoring pathways, and is used downstream in ranking, incentive allocation, or quality monitoring.

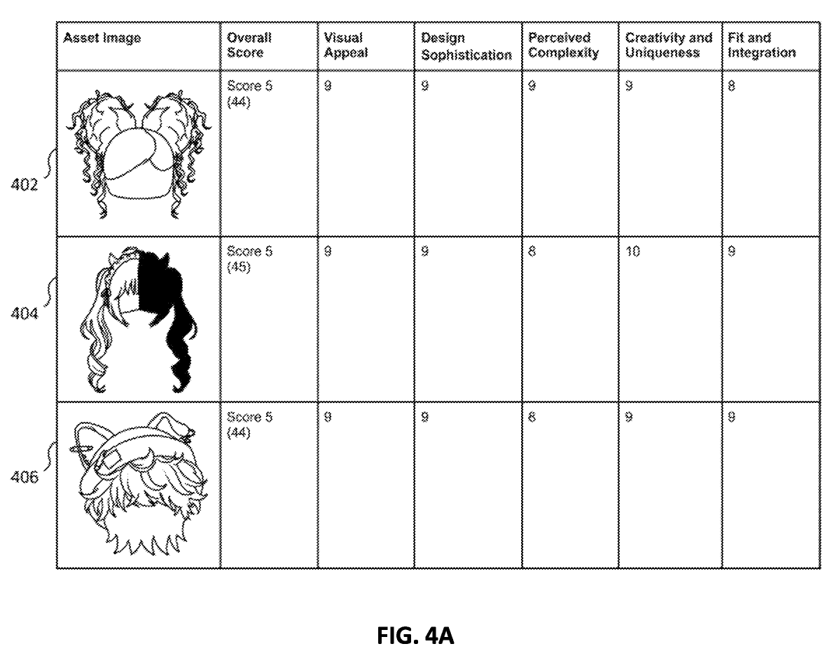

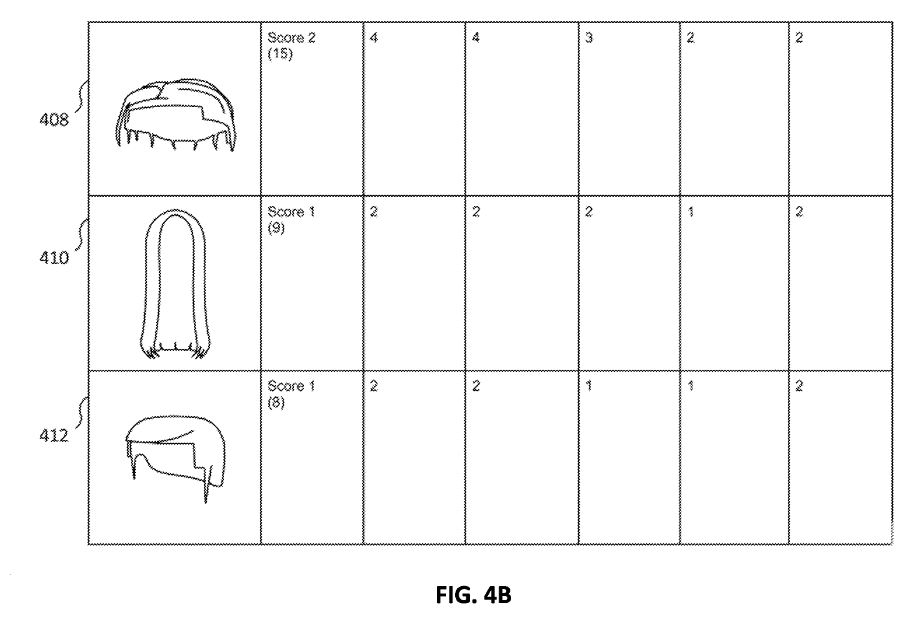

FIG. 4A is a diagram illustrating example scoring results for a set of higher-quality virtual assets in the category of hair, in accordance with some implementations. The hair category is used as an example here. Each row of the diagram corresponds to a particular virtual asset image and provides (in corresponding columns of the diagram) an overall score as well as individual numeric scores assigned across several quality dimensions. The quality dimensions include visual appeal, design sophistication, perceived complexity, creativity and uniqueness, and fit and integration. The assets shown correspond to virtual items that were originally submitted by users as UGC. For purposes of the discussion in the figure, such UGC items are referred to as virtual assets.

The virtual asset at 402 is a stylized hair accessory. The asset received an overall score of 5, with a numeric total of 44. Individual scores included 9 for visual appeal, 9 for design sophistication, 9 for perceived complexity, 9 for creativity and uniqueness, and 8 for fit and integration. The virtual asset at 404 shows a split-color hair accessory. The item received an overall score of 5 and a numeric total of 45. It was scored with 9 for visual appeal, 9 for design sophistication, 8 for perceived complexity, 10 for creativity and uniqueness, and 9 for fit and integration. The elevated score in creativity and uniqueness may reflect the distinct use of color and the incorporation of theme elements.

The virtual asset at 406 is a stylized hair accessory with cat ears. The asset also received an overall score of 5, with a numeric total of 44. Scores included 9 for visual appeal, 9 for design sophistication, 8 for perceived complexity, 9 for creativity and uniqueness, and 9 for fit and integration.

FIG. 4B is a diagram illustrating additional example virtual assets in the hair category with lower aggregate scores across multiple evaluation criteria, in accordance with some implementations. Each row of the diagram corresponds to a distinct hair accessory or hairstyle uploaded as a virtual asset to the platform. Items 408, 410, and 412 are shown (in corresponding columns of the diagram) with their respective aggregated overall quality scores and underlying per-criterion values. For example, the asset at 408 has an overall score of 2, derived from individual values such as 4, 4, 3, 2, and 2 across different quality axes. The assets at 410 and 412 both have an overall score of 1, with lower associated values such as 2, 2, 1, 1, and 2 for individual criteria. The scores reflect model-generated evaluations of visual or structural features of the hair virtual assets, such as stylistic alignment, geometric integrity, or presentation consistency.

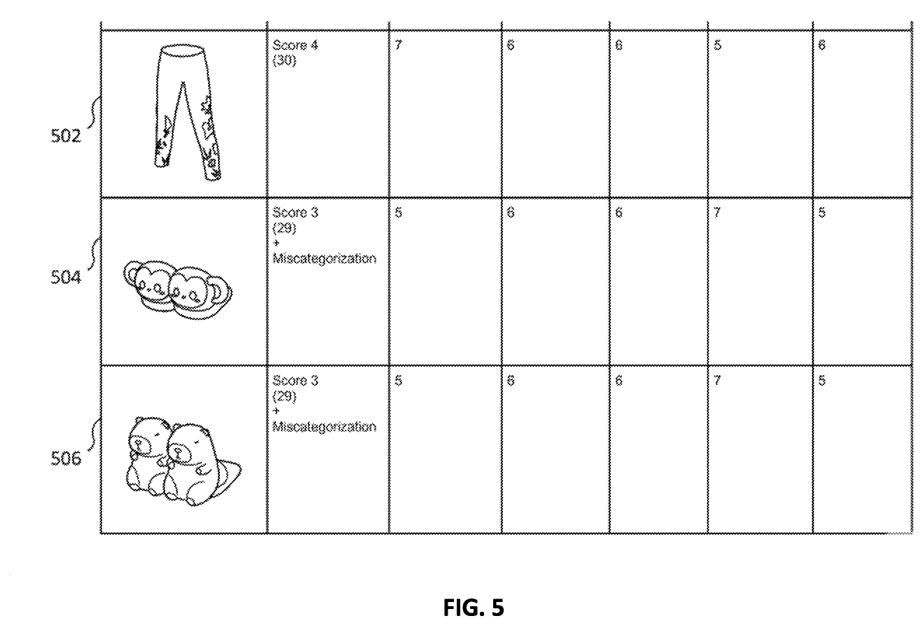

FIG. 5 is a diagram illustrating an example comparative evaluation of virtual assets categorized under pants, including cases of miscategorization, in accordance with some implementations. The asset shown in row 502 is a virtual pants item that received a final overall score of 4 based on a raw score of 30. The asset exhibits relatively high scores across the evaluation criteria columns, including values such as 7, 6, 6, 5, and 6, reflecting strong performance across multiple dimensions. Rows 504 and 506 depict virtual assets that were initially categorized as pants, but were later determined to be shoe accessories. Both received raw scores of 29 and final overall scores of 3. Despite relatively comparable criterion-level scores to the item in row 502, their miscategorization as pants impacted the final score assigned by the evaluation. The inclusion of a miscategorization indicator illustrates how classification accuracy affects overall scoring.

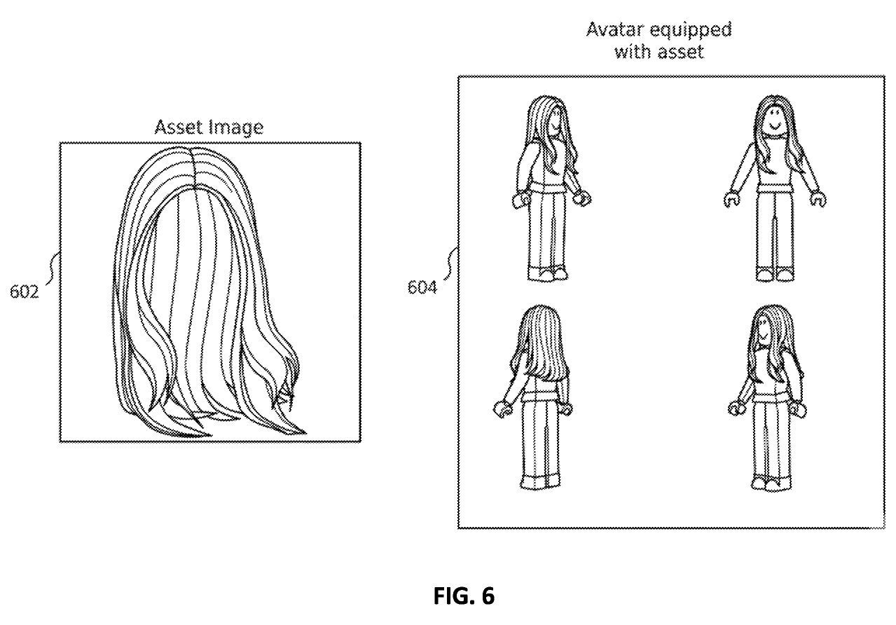

FIG. 6 is a diagram illustrating an example composite image associated with a virtual asset, in accordance with some implementations. The composite image includes a standalone asset image 602 and a composite image 604 of an avatar equipped with the asset. The asset image 602 presents a frontal depiction of the virtual asset, such as a hairstyle, rendered independently of any avatar. The composite image 604 includes several rendered views of a digital avatar configured with the asset, including front-facing, side, and rear perspectives, enabling contextual evaluation of how the asset appears when worn. The composite image 604 may be used as input to the AI model in order to enable criteria scoring. In some implementations, the composite image 604 may be displayed for human reviewers performing manual determination.

### Computing device

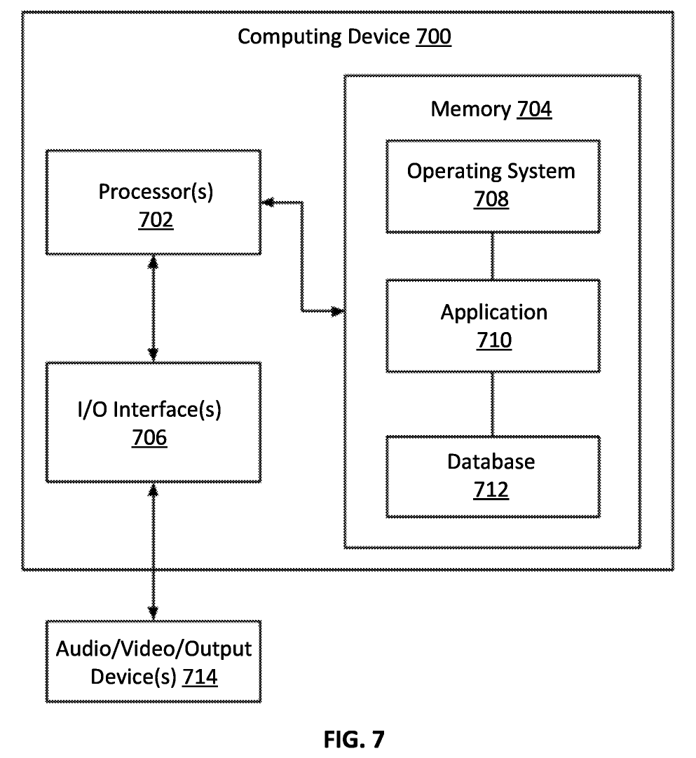

FIG. 7 is a block diagram of an example computing device 700 which may be used to implement one or more techniques described herein. In one example, device 700 may be used to implement a computer device (e.g., 102, 130, and/or 110 of FIG. 1), and perform method implementations described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714.

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 704 is provided in device 700 for access by the processor 702, and may be any suitable computer-readable or processor-readable storage medium (e.g., random access memory (RAM), read-only memory (ROM), electrical erasable read-only memory (EEPROM), flash memory, etc.), suitable for storing instructions for execution by the processor, and located separate from processor 702 and/or integrated therewith. Memory 704 can store software operating on the device 700 by the processor 702, including an operating system 708, one or more applications 710, and a database 712 that may store data used by the components of device 700.

Database 712 (which can correspond to the data store 120 of FIG. 1 in some implementations) may store one or more mechanisms, including semantic tags, evaluation criteria, and configurations for determining the quality of virtual assets in a virtual marketplace. In some implementations, database 712 may store information associated with virtual assets, such as unique identifiers for each asset, metadata describing their categorization (e.g., shirts, hats, or accessories), and evaluation data reflecting their visual appeal, design sophistication, and other quality metrics. The stored data can include, e.g., historical quality scores, prompt configurations for AI model(s), and composite images of virtual assets equipped on avatars. For example, in a virtual marketplace, the database might store quality scores generated for individual assets based on criteria, along with the corresponding composite images and evaluation prompts used during the scoring process. In some implementations, database 712 may store other data relevant to asset evaluation, such as filtering rules, prompt optimization configurations, and session data for managing iterative evaluations. Applications 710 can include instructions that enable processor 702 to execute the described techniques, such as categorizing assets, generating prompts, and processing composite images to produce quality scores.

For example, applications 710 can include a module that implements one or more techniques or services described herein, such as assigning respective asset types to a set of virtual assets using semantic tags, generating evaluation prompts, or computing quality scores based on criteria. As shown in FIG. 1, the virtual experience applications 112 and 132 and/or the virtual experience engine 104 and graphics engine 108 can implement the functionality of application 710. Applications 710 can incorporate real-time or near-real-time updates to monitor and refine the scoring process. The applications 710 may employ various mechanisms to enhance evaluation accuracy, including optimizing prompts using contextual cues, adjusting criteria for new asset types, and ensuring alignment with human evaluation standards. Database 712 (and/or other connected storage) can store various data used in the described techniques, including semantic tags, historical evaluation records, composite images, and parameters for scoring criteria or prompt generation based on specific asset attributes.

Elements of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered "storage" or "storage devices."

I/O interface 706 (which can correspond to the I/O interfaces 114/134 of FIG. 1 in some implementations) can provide functions to enable interfacing the device 700 with other systems and devices. For example, network communication devices, storage devices (e.g., memory and/or data store 120), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 714 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 7 shows one block for each of processor 702, memory 704, I/O interface 706, operating system 708, and application 710. The blocks may represent one or more processors or processing circuitries, operating systems, memories, I/O interfaces, applications, and/or software engines. In other implementations, device 700 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may correspond to the device 700 and perform the operations described.

Device 700 can be a server device or client device. Example client devices or user devices can be computer devices including some similar components as the device 700 (e.g., processor(s) 702, memory 704, and I/O interface 706). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 714, for example, can be connected to (or included in) the device 700 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
assigning respective asset types to a plurality of virtual assets within a virtual platform, wherein the assigning includes using semantic tags;
sampling a subset of virtual assets from each of two or more of the asset types, thereby generating a plurality of subsets;
evaluating each virtual asset in the subsets based on a set of criteria;
generating, using an artificial intelligence (AI) model, a set of prompts corresponding to the criteria by analyzing distinguishing attributes between virtual assets in the subsets that meet a threshold under the criteria and virtual assets in the subsets that fail to meet the threshold under the criteria;
constructing composite images for each virtual asset in the subsets, wherein each composite image comprises a plurality of rendered views of an avatar equipped with the virtual asset;
providing the composite images, the semantic tags, and the generated set of prompts as input to the AI model;
receiving, as output from the AI model, a set of quality scores associated with the criteria for each virtual asset in the subsets and an overall quality score for each virtual asset in the subsets; and
utilizing the overall quality scores for the virtual assets in the subsets within one or more applications within the virtual platform.

2. The method of claim 1, wherein evaluating each virtual asset comprises excluding a virtual asset from the evaluation based on one or more eligibility conditions defined by a filtering policy.

3. The method of claim 1, wherein the set of criteria comprises one or more of visual appeal, design sophistication, perceived complexity, creativity, and fit and integration.

4. The method of claim 1, wherein the set of criteria comprises theme consistency, and wherein the theme consistency is determined based on alignment between the virtual asset and a modeled distribution of semantically related assets.

5. The method of claim 1, further comprising:
analyzing differences in attribute distributions between virtual assets in the subsets that meet the threshold under the criteria and virtual assets in the subsets that fail to meet the threshold; and
generating the set of prompts based on the analyzing the differences in the attribute distributions.

6. The method of claim 1, wherein each composite image comprises multiple rendered views of the avatar, and wherein each rendered view depicts a different orientation of the virtual asset as equipped on the avatar.

7. The method of claim 1, further comprising:
analyzing image data and metadata associated with each virtual asset in the plurality of virtual assets to generate the semantic tags used for assigning the respective asset types.

8. The method of claim 1, wherein the AI model is further configured to generate, for each virtual asset in the subsets, an explanation for at least one of the quality scores associated with the criteria.

9. The method of claim 1, wherein the overall quality score is computed by applying a weighted aggregation to the quality scores associated with the criteria, and wherein the weights are assigned based on importance values.

10. The method of claim 1, further comprising:
updating the set of prompts based on differences between the quality scores output from the AI model and feedback received from human evaluators.

11. The method of claim 1, wherein utilizing the overall quality scores comprises adjusting a display ranking of the virtual assets in a content discovery interface of the virtual platform.

12. The method of claim 1, wherein utilizing the overall quality scores comprises adjusting one or more incentive parameters associated with a creator account linked to each respective virtual asset.

13. The method of claim 1, wherein the AI model comprises a large language model (LLM).

14. A computing device comprising:
one or more processors; and
memory coupled to the one or more processors with instructions stored thereon that, when executed by the one or more processors, cause the one or more processors to perform or control performance of operations comprising:
assigning respective asset types to a plurality of virtual assets within a virtual platform, wherein the assigning includes using semantic tags;
sampling a subset of virtual assets from each of two or more of the asset types, thereby generating a plurality of subsets;
evaluating each virtual asset in the subsets based on a set of criteria;
generating, using an artificial intelligence (AI) model, a set of prompts corresponding to the criteria by analyzing distinguishing attributes between virtual assets in the subsets that meet a threshold under the criteria and virtual assets in the subsets that fail to meet the threshold under the criteria;
constructing composite images for each virtual asset in the subsets, wherein each composite image comprises a plurality of rendered views of an avatar equipped with the virtual asset;
providing the composite images, the semantic tags, and the generated set of prompts as input to the AI model;
receiving, as output from the AI model, a set of quality scores associated with the criteria for each virtual asset in the subsets and an overall quality score for each virtual asset in the subsets; and
utilizing the overall quality scores for the virtual assets in the subsets within one or more applications within the virtual platform.

15. The computing device of claim 14, wherein evaluating each virtual asset comprises excluding a virtual asset from the evaluation based on one or more eligibility conditions defined by a filtering policy.

16. The computing device of claim 14, wherein the set of criteria comprises one or more of visual appeal, design sophistication, perceived complexity, creativity, and fit and integration.

17. The computing device of claim 14, wherein the set of criteria comprises theme consistency, and wherein the theme consistency is determined based on alignment between the virtual asset and a modeled distribution of semantically related assets.

18. The computing device of claim 14, wherein the instructions further cause the one or more processors to perform or control performance of operations comprising:
analyzing differences in attribute distributions between virtual assets in the subsets that meet the threshold under the criteria and virtual assets in the subsets that fail to meet the threshold; and
generating the set of prompts based on the analyzing the differences in the attribute distributions.

19. The computing device of claim 14, wherein each composite image comprises multiple rendered views of the avatar, and wherein each rendered view depicts a different orientation of the virtual asset as equipped on the avatar.

20. A non-transitory computer-readable medium with instructions stored thereon that, when executed by a processor, cause the processor to perform or control performance of operations comprising:
assigning respective asset types to a plurality of virtual assets within a virtual platform, wherein the assigning includes using semantic tags;
sampling a subset of virtual assets from each of two or more of the asset types, thereby generating a plurality of subsets;
evaluating each virtual asset in the subsets based on a set of criteria;
generating, using an artificial intelligence (AI) model, a set of prompts corresponding to the criteria by analyzing distinguishing attributes between virtual assets in the subsets that meet a threshold under the criteria and virtual assets in the subsets that fail to meet the threshold under the criteria;
constructing composite images for each virtual asset in the subsets, wherein each composite image comprises a plurality of rendered views of an avatar equipped with the virtual asset;
providing the composite images, the semantic tags, and the generated set of prompts as input to the AI model;
receiving, as output from the AI model, a set of quality scores associated with the criteria for each virtual asset in the subsets and an overall quality score for each virtual asset in the subsets; and
utilizing the overall quality scores for the virtual assets in the subsets within one or more applications within the virtual platform.
